(19) United States
(12) Patent Application Publication
(10) Pub. No.: US 2010/0299209 A1
(43) Pub. Date: Nov. 25, 2010

(54) ADVERTISEMENT ALLOCATION BASED ON USER POPULATION FREQUENCY CAPPING

(75) Inventors: Aranyak Mehta, Mountain View, CA (US); Shanmugavelayutham Muthukrishnan, New York, NY (US); Seyed Vahab Mirrokni Banadaki, Brooklyn, NY (US); Jon Feldman, New York, NY (US)

Correspondence Address: FISH & RICHARDSON P.C., PO BOX 1022, MINNEAPOLIS, MN, 55440-1022, US

(73) Assignee: GOOGLE INC., Mountain View, CA (US)

(21) Appl. No.: 12/605,821

(22) Filed: Oct. 26, 2009

Related U.S. Application Data
(60) Provisional application No. 61/180,662, filed on May 22, 2009.

(51) Int. Cl. G06Q 30/00

(52) U.S. Cl. 705/14.66; 705/14.73

(57) ABSTRACT

Systems and methods for providing advertisements in response to impression events (e.g., a request for a placement of an advertisement) corresponding to forecasted impressions (e.g., a forecast of a request for a placement of an advertisement). The advertisements are allocated according to solution data that respects frequency caps on the number of times the advertisement can be presented to a particular user population.

### CROSS-REFERENCED TO RELATED APPLICATIONS

This application claims the benefit under 35 U.S.C. §119(e) of U.S. patent application Ser. No. 61/180,662, titled “ADVERTISEMENT ALLOCATION BASED ON USER POPULATION FREQUENCY CAPPING,” filed May 22, 2009, which is incorporated herein by reference.

### BACKGROUND

This disclosure relates to online advertising.

Advertisement delivery providers facilitate the presentation of advertisements from numerous advertisers on network resources (e.g., web pages). In general, an advertisement delivery provider routinely services the same network resources. Thus the advertisement delivery provider is aware of the advertisement traffic on those network resources. Advertisement delivery providers can utilize known advertisement traffic data to forecast advertisement traffic (e.g., demand for advertisements) on the network resources for a future time period.

### SUMMARY

In general, the subject matter of this specification relates to systems and methods for allocating advertisements.

One aspect of the subject matter described in this specification can be embodied in a method including identifying forecasting data defining forecasted impressions for a plurality of user populations for a time period, each forecasted impression associated with a corresponding user population; identifying advertisement availability data defining availabilities of advertisements to be provided during the time period, each advertisement associated with one or more user populations, each advertisement and user population being associated with a corresponding maximum number of times the advertisement is to be presented to the user population; generating solution data comprising a solution set defining a plurality of advertisement and forecasted impression sets, wherein each advertisement and forecasted impression set includes no more than its corresponding maximum number of advertisement and forecasted impression pairs, and each advertisement and forecasted impression pair in the advertisement and forecasted impression set defines a match of the advertisement to one forecasted impression associated with the same user population as the advertisement, wherein the one forecasted impression is matched only once; and in response to an impression event corresponding to a forecasted impression, providing the advertisement matched with the forecasted impression according to the advertisement and impression pair corresponding to the forecasted impression.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an example graph representing solution data for allocating advertisements to forecasted impressions based on forecasting data and advertisement availability data.

FIG. 2 is a block diagram of an example environment in which an advertisement allocation system can be implemented.

FIG. 3 is a flow diagram of an example process for providing advertisements in response to impression events based on forecasting data and advertisement availability data.

FIG. 4 is an example graph relating advertisements to forecasted impressions.

FIG. 5 is a flow diagram of an example process for generating solution data.

FIG. 6 is an example graph depicting nodes and edges used to generate solution data.

FIG. 7 is block diagram of an example computer system.

Like reference numbers and designations in the various drawings indicate like elements.

### DETAILED DESCRIPTION

In general, the subject matter of this specification relates to allocating advertisements to forecasted impressions for particular user populations according to solution data. A forecasted impression is a forecast of an impression event during a future time period. Thus the solution data can be used to determine which advertisements to allocate to impression events from particular user populations that occur during the future time period. The solution data reflect the constraints placed on the allocation of advertisements to the forecasted impressions (and corresponding impression events) for particular user populations.

The solution data are generated from forecasting data and advertisement availability data, and, as described above, are used to allocate advertisements to impression events. An impression event is a request for an advertisement for a particular network resource, such as a web page. A user population can be a demographic associated with users of client devices, e.g., a geographical area from which the impression event originated, a type of client device (or software running on the client device) causing the impression event, or a characteristic (age, gender) of users causing the client devices to generate the impression events.

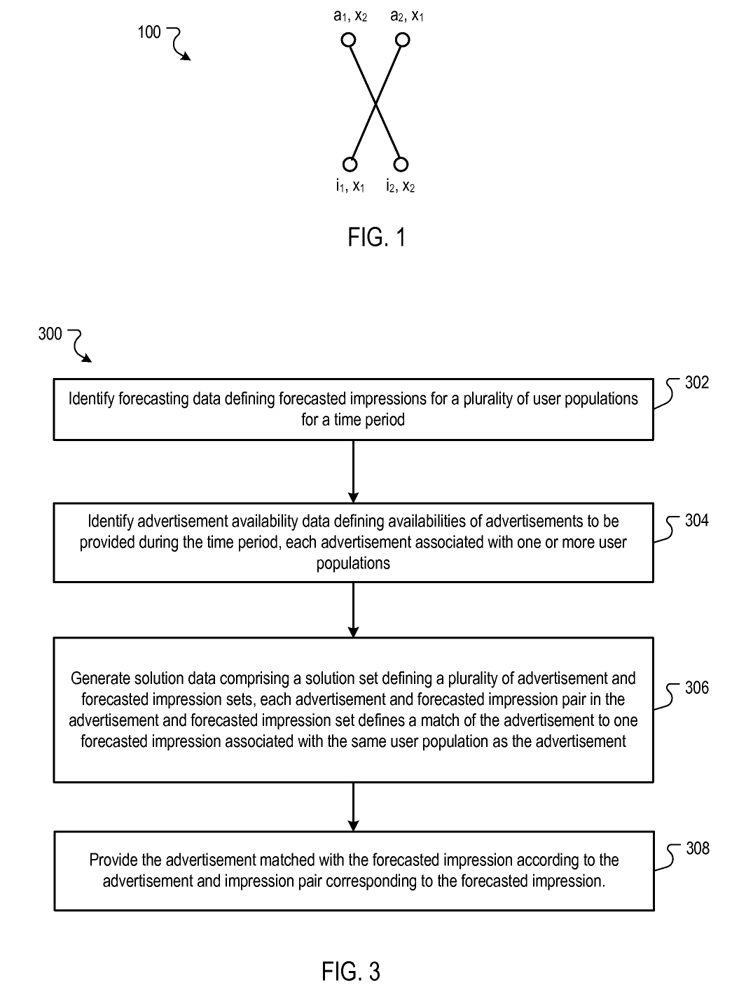

FIG. 1 is an example graph representing solution data for allocating advertisements to forecasted impressions based on forecasting data and advertisement availability data.

The forecasting data specify forecasts of impression events during a future time period for specific user population demographics. For example, the forecasting data may indicate that network resource i₁ (e.g., www.example1.com) and network resource i₂ (e.g., www.example2.com) will each request placement of an advertisement during a future time period for presentation to user populations x₁ (e.g., males) and x₂ (e.g., females), respectively. In other words, the request from network resource i₁ will be caused by a client device used by a male user (i₁, x₁ on graph 100) and the request from network resource i₂ will be caused by a client device used by a female user (i₂, x₂ on graph 100). The forecasting data can be derived from past advertisement traffic data on the network resources.

The advertisement availability data specify a set of advertisements available to be presented to particular user populations during a future time period. For example, the advertisement availability data may indicate that advertisement a₁ is to be presented to user population x₂ (a₁, x₂ on graph 100), and that advertisement a₂ is to be presented to user population x₁ (a₂, x₁ on graph 100). The advertisement availability data can be determined, for example, from advertisement sale contracts for a future time period or projected from historical advertisement availability information. For example, an advertiser may purchase 1,000 impressions on a particular web site and target the 1,000 impressions to a particular demographic, e.g., women in the 35-45 year old age group.

The solution data define allocations of advertisements to forecasted impressions in accord with user population constraints as identified from the forecasting data and the advertisement availability data. In FIG. 1, for example, the solution data indicate that advertisement a₁, targeted to user population x₂, should be allocated to the forecasted impression from network resource i₂ with user population x₂ because the respective user populations are the same. The solution data also indicate that advertisement a₂, to be presented to user population x₁, should be allocated to the forecasted impression from network resource i₁ with user population x₁ because the respective user populations are the same. Assuming that the forecasted impressions from network resources i₁ and i₂ occur (they may not as they are forecasts/projections), the advertisements a₁ and a₂ will be allocated in accord with the solution data.

The advertisement availability data may also define limits on the number of times an advertisement can be presented to a given user population (a “frequency cap”). The frequency cap can, for example, as set by the advertiser. For example, an advertiser may want its advertisement or campaign to be presented to a specific user population no more than fifty times out of two-hundred requested impressions for the advertisement during the time period. The advertiser may want to limit the number of impressions to the same user population for numerous reasons. For example, the advertiser may want the advertisement to be shown to multiple user populations to reach a diverse audience.

The solution data are generated to account for the frequency caps placed on the advertisements by the advertisers. For example, if an advertiser specifies that an advertisement is not to be presented to user population x₁ more than ten times and user population x₂ more than five times, then the solution data will not define allocations of the advertisement in a manner that violates the specified frequency caps. Once generated, the solution data are used by an advertisement allocation system to serve advertisements for impressions.

### §1.0 Example Operating Environment

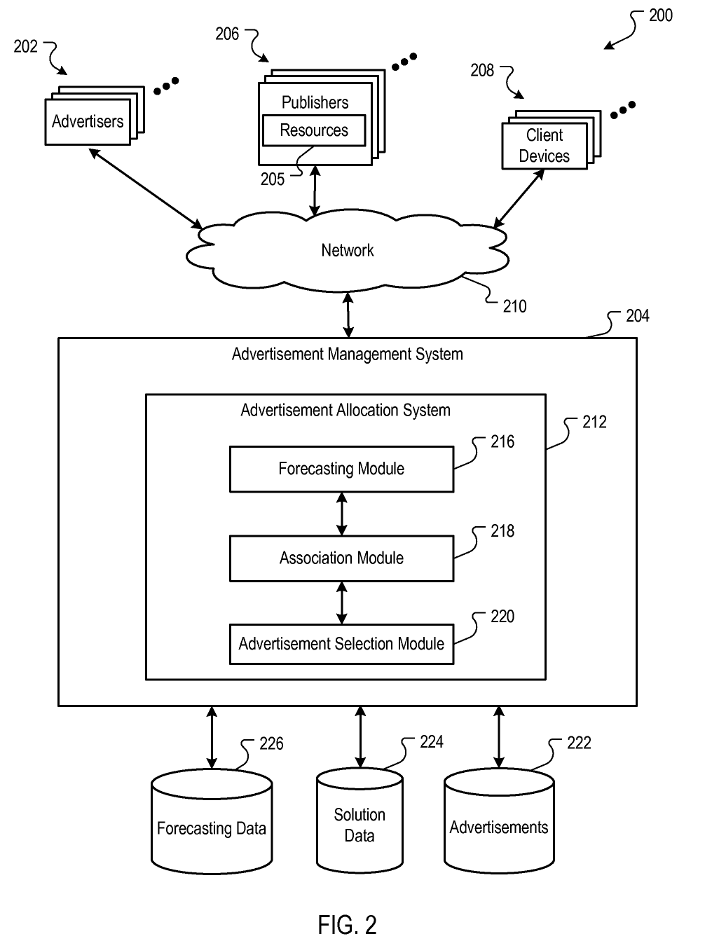

FIG. 2 is a block diagram of an example environment 200 in which an advertisement allocation system 212 can be implemented. The online environment 200 can facilitate the identification and serving of web content, e.g., web pages, advertisements, etc., to users. A computer network 210, such as a local area network (LAN), wide area network (WAN), the Internet, or a combination thereof, connects advertisers 202, an advertisement management system 204, publishers 206, and client devices 208. The online environment 200 may include numerous advertisers 202, publishers 206 and client devices 208.

One or more advertisers 202 can directly, or indirectly, enter, maintain, and track advertisement information in the advertising management system 204. The advertisements can be in the form of graphical advertisements, such as banner advertisements, text only advertisements, image advertisements, audio advertisements, and video advertisements.

A web site is a one or more web page resources 205 associated with a domain name, and each web site is hosted by one or more servers. An example web site is a collection of web pages formatted in hypertext markup language (HTML) that can contain text, graphic images, multimedia content, and programming elements, such as scripts. Each web site is maintained by a publisher 206, e.g., an entity that manages and/or owns the web site. For brevity, the term “publisher” 206 will also be used to refer to a web site that is managed and/or owned by the publisher.

A client device 208 is an electronic device that is under the control of a user and is capable of requesting and receiving data over the network 210. A client device 208 typically includes a user application, such as a web browser, to facilitate the sending and receiving of data over the network 210, such as requesting a resource (e.g., page content) from a publisher 206. Example client devices 208 include personal computers, mobile communication devices, and other devices that can send and receive data over the network 210.

The system 204 can facilitate an auction to determine which advertisements are to be selected and provided to requesting publishers 206. However, in some advertisement schemes, the advertisers 202 contract with an advertisement delivery provider and/or publisher to set a predetermined number of impression events that their advertisements are to satisfy (e.g., a number of impressions the advertisers desire for their advertisements). The advertisers 202 also provide requirements, in the form of advertisement availability data, as to which network resources or group or category of network resources their advertisements are to be placed, to which user demographics their advertisements are to be presented, and corresponding frequency caps.

### §2.0 Advertisement Allocation System

The advertisement management system 204 includes an advertisement allocation system 212. The advertisement allocation system 212 allocates and provides advertisements in response to impression events corresponding to forecasted impressions based on forecasting data and advertisement availability data. The advertisement allocation system 212 includes a forecasting module 216, an association module 218 and an advertisement selection module 220. The operation of the forecasting module 216, the association module 218, and the advertisement selection module 220 is described below.

### §2.1 Exemplary Process for Allocating Advertisements

FIG. 3 is a flow diagram of an example process for providing advertisements in response to impression events based on forecasting data and advertisement availability data. The process 300 can be implemented in the advertisement allocation system 212.

Forecasting data defining forecasted impressions for a plurality of user populations for a time period is determined (302). The forecasting data include data that associate each forecasted impression with the user population causing the impression event projected by the forecasted impression. For example, the forecasting data may indicate that during a future time period network resource i₁, network resource i₂, and network resource i₃ will have impression events, i.e., requests for placements of advertisements, from user populations x₃ (e.g., users between 25 and 35 years old), x₄ (e.g., user John Smith) and x₁, respectively. The forecasting data can be derived from past advertisement traffic for those network resources. In some implementations, the forecasting data 216 can be provided to the forecasting module 216. In other implementations, the forecasting data 216 can be generated by the forecasting module 216. A variety of forecasting methods and algorithms can be used to generate the forecasting data 216.

Advertisement availability data defining availabilities of advertisements to be provided during the time period are identified (304). The advertisement availability data specify which advertisements are available to be served during which time periods. The advertisement availability data include data that associate each advertisement with one or more user populations. For example, the advertisement availability data specify that advertisement aₓ only be presented to user populations x₁ and x₂, i.e., advertisement aₓ is associated with user populations x₁ and x₂.

The advertisement availability data further include data that associate each advertisement and user population to which the advertisement is to be presented with a maximum number of times the advertisement is to be presented to that user population, i.e., frequency cap. For example, the advertisement availability data reflect that advertisement aₓ is to be presented to user populations x₁ and x₂ no more than five and ten times, respectively.

The advertisement availability data can also include data specifying that advertisements only be served to specific network resources or groups of network resources. For example, an advertiser may specify that its advertisement only be presented on network resource i₁ to user population x₁ with a frequency cap of thirty.

Publishers may also restrict the types of advertisements that may be placed on their network resources, and the restrictions can be represented in the advertisement availability data. For example, the publisher of network resource i₁ may specify that only advertisements with a particular subject matter may be served for the impression i₁. The forecasting module 216 can receive and/or identify the advertisement availability data from the advertising data store 222.

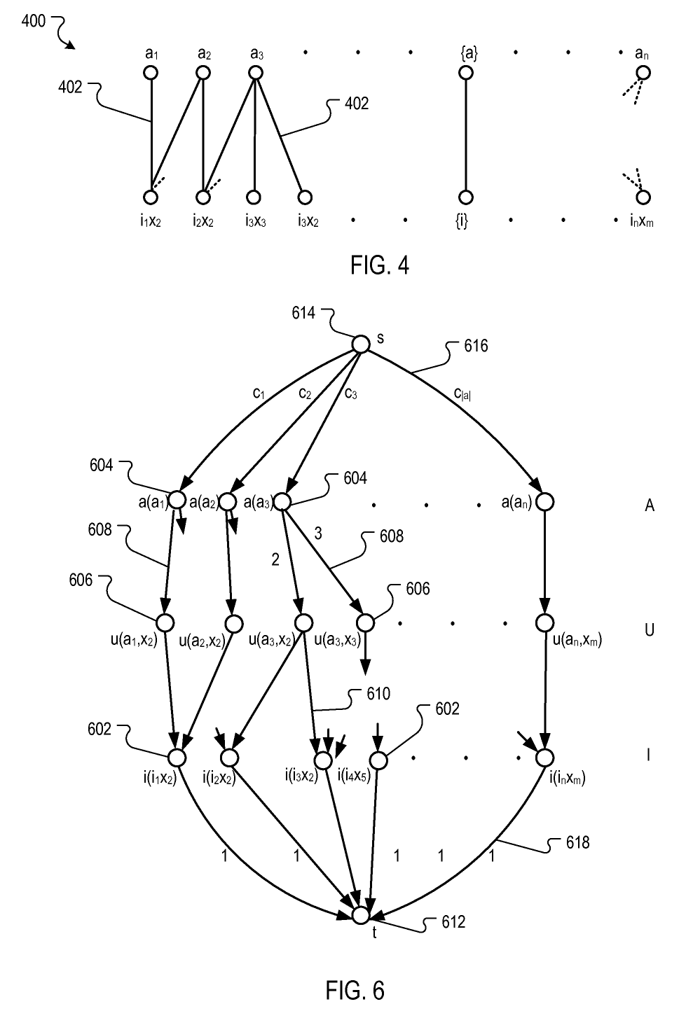

Such publisher and advertiser restrictions are illustrated in FIG. 4, which is an example graph 400 relating advertisements to forecasted impressions. The forecasting data and advertisement availability data may be used by the association module 218 to generate the graph 400 relating forecasted impressions to advertisements that are allowed to be allocated to those forecasted impressions.

An advertisement is allowed to be allocated to a forecasted impression if there are no restrictions in the advertisement availability data prohibiting the allocation. Allowable allocations can be represented on graph 400 as edges 402 between forecasted impressions (e.g., i₁x₁, i₂x₂, i₃x₁ . . . iₙxₘ) and advertisements (e.g., a₁, a₂, a₃ . . . aₙ). In graph 400, i₁x₁ is a forecasted impression for network resource i₁ from user population x₁, i₂x₂ is a forecasted impression for network resource i₂ from user population x₂, i₃x₁ is a forecasted impression for network resource i₃ from user population x₁.

Each edge 402 between an advertisement and a forecasted impression is an allowable allocation based on, for example, advertiser requirements/restrictions specified in the advertisement availability data. For example, advertisement a₃ shares edges with i₂x₂, i₃x₃ and i₃x₂, so a₃ could be allocated to i₂x₂, 1₃X₃ or i₃x₂. Further, a₁ is only permitted to be allocated to i₁x₂.

As explained above, a forecasted impression is a forecast of a request for a particular network resource for placement of an advertisement on the network resource. It will often be the case that multiple placements for advertisements during a time period will be requested for the network resource. For example, network resource i₁ may be accessed by hundreds of different users during a given time period and for each user the network resource may request placement of one or more advertisements.

Multiple forecasted impressions from the same network resource can be represented on graph 400 by duplicates of the relevant forecasted impression. For example, if forecasted impression iₙxₘ is a forecast of a request for network resource iₙ from user population xₘ and it is projected that network resource iₙ will request the placement of ten advertisements for user population xₘ, then forecasted impression iₙxₘ can be duplicated nine times (e.g., iₙ₊₁xₘ , iₙ₊₂xₘ . . . iₙ₊₉xₘ) and those duplicates can be represented on graph 400 with the same edges to the same advertisements as iₙxₘ. Likewise if network resource iₙ is also projected to request the placement of four advertisements for user population x_{b} then forecasted impression iₙx_{b} can be represented four times on the graph 400.

Solution data comprising a solution set defining a plurality of advertisement and forecasted impression sets are generated (306). For example, the association module 218 can generate solution data from the graph 400 of FIG. 4 and store the solution data in the solution data store 224. An advertisement and forecasted impression set is an advertisement and all of the forecasted impressions to which the advertisement has been allocated for one user population associated with the advertisement (e.g., a user population to which an advertiser permits or requests the advertisement to be presented). For one user population associated with the advertisement, each allocation of the advertisement to a forecasted impression is an advertisement and forecasted impression pair.

An advertisement and forecasted impression pair is a match of the advertisement to one forecasted impression associated with the same user population as the advertisement. A match is an identification from the solution data that the advertisement has been allocated to the forecasted impression. A forecasted impression can be matched only once, i.e., once a forecasted impression is matched it cannot be matched to another advertisement.

The number of advertisement and forecasted impression pairs in an advertisement and impression set is the number of times the solution data has allocated the advertisement to forecasted impressions for a particular user population associated with the advertisement. For example, advertisement aₓ may be associated with user population x₁, and can be presented no more than five times to user population x₁ (e.g., the frequency cap as specified in the advertisement availability data). If the solution data allocate advertisement aₓ four times to four forecasted impressions, then the advertisement and forecasted impression set would include four advertisement and forecasted impression pairs. The number of advertisement and forecasted impression pairs in an advertisement and forecasted impression set cannot exceed the frequency cap for the advertisement with respect to the user population.

The advertisement matched with the forecasted impression is provided according to the advertisement and impression pair corresponding to the forecasted impression in response to an impression event corresponding to the forecasted impression (308). For example, the advertisement selection module 220 can provide the advertisement in response to an impression event.

As mentioned above, in some implementations, the advertisement allocation system 212 identifies forecasting data, identifies advertisement availability data, and generates solution data in an offline process prior to the time period relevant to the forecasting data. The solution data can then be used to determine which advertisements to provide in response to impression events as the impressions events occur (i.e., a real-time or near real-time, online process).

### §2.2 Exemplary Process for Generating Solution Data

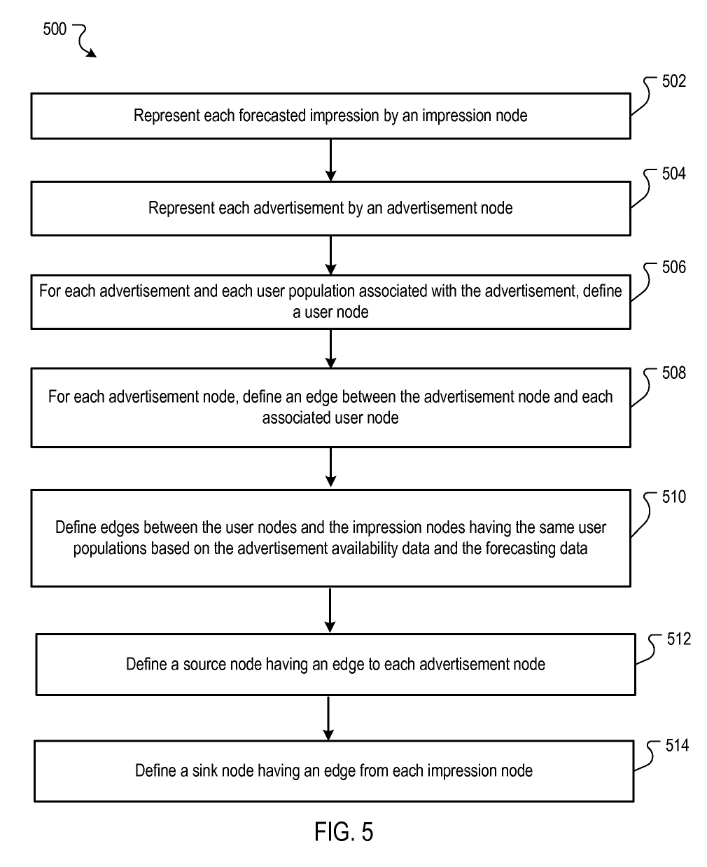

An example process for generating solution data is described with reference to FIGS. 5 and 6. FIG. 5 is a flow diagram of an example process 500 for generating solution data. FIG. 6 is an example graph 600 depicting nodes and edges used to generate solution data. The graph 600 can be generated, for example, according to the process 500. The process 500 can be implemented by the association module 218. The nodes, edges and values described below can all be defined and managed in a computer memory.

Each forecasted impression is represented by an impression node (502). For example, each forecasted impression identified from the forecasting data is represented on a graph by a node (or any other data structure or representation that organizes data). The association module 218 can, for example, represent each forecasted impression by an impression node, such as impression nodes 602 (e.g., i(i₁x₂) and i(i₂x₂) representing forecasted impressions (i₁x₂) and (i₂x₂) of FIG. 4, respectively).

Each advertisement is represented by an advertisement node (504). For example, each advertisement identified from the advertisement availability data is represented by a node. The association module 218 can, for example, represent each advertisement by an advertisement node, such as advertisement nodes 604 (e.g., a(a₁) and a(a₃) representing advertisements a₁ and a₃ of FIG. 4, respectively).

For each advertisement and each user population associated with the advertisement, a user node is defined (506). The association module 218 can, for example, define a user node for each advertisement and each user population associated with the advertisement. For example, if an advertiser of advertisement a₃ specifies the advertisement a₃ to be presented to user populations x₂ and x₃, then two user nodes are defined-u(a₃x₂) and u(a₃x₃). The association module 218 can, for example, define user nodes 606.

For each advertisement node, an edge is defined between the advertisement node and each associated user node (508). The association module 218 can, for example, define an edge 608 between the advertisement node 604 (e.g., a(a₃)) and each associated user node 606 (e.g., u(a₃x₂) and u(a₃x₃)). Each edge has a capacity corresponding to the maximum number of times the advertisement represented by the advertisement node is to be presented to the associated user population, i.e., the capacity is equal to the frequency cap for associated the user population. A capacity defines the maximum number of distinct paths (e.g., solution paths) allowed by an edge during the solution data generation process, such as a max flow solution process. For example, advertisement a₃ may have a frequency cap of three with respect to user population x₃. Thus the capacity of the edge between the advertisement node representing advertisement a₃ (e.g., node a(a₃)) and the associated user node (e.g., u(a₃x₃)) is three.

Edges between the user nodes and the impression nodes having the same user populations are defined based on the advertisement availability data and the forecasting data (510). The edge defined between a user node and an impression node has a capacity of one. The edges can be, for example, defined in accord with the advertiser and/or publisher requirements/restrictions included in the advertisement availability data, and the user populations associated with the forecasted impressions included in the forecasting data. Thus these edges correspond to allowable allocations of the advertisement to the forecasted impressions, as discussed above.

The number of edges coming from a user node cannot exceed the capacity of the edge between the associated advertisement node and the user node. For example, an edge 610 can be defined between user node 606 (u(a₃x₂)) and impression nodes 602 (i(i₂x₂) and i(i₃x₂)). No more than two edges can come from user node 606 (u(a₃x₂)) because the capacity of the edge 608 to the user node 606 (u(a₃x₂)) from advertisement node 604 (a(a₃)) is two. Depending on the forecasting data and advertisement availability data, not all impression nodes and/or user nodes will have an edge (e.g., advertiser restrictions/requirements for serving the advertisements). The association module 218 can, for example, define an edge 610 between a user node 606 and an impression node 602.

The advertisement a₃ being associated with user population x₂ represented by user node 606 (u(a₃x₂)) and allocated to forecasted impressions i₂x₂ and i₃x₂ represented by impression nodes 602 (i(i₂x₂) and i(i₃x₂)), respectively, in the solution data, corresponds to two advertisement and forecasted impression pairs. The first pair is the advertisement a₃ associated with user population x₂ and forecasted impression i₂x₂, and the second pair is the advertisement a₃ associated with user population x₂ and forecasted impression i₃x₂. These two pairs (i.e., a match of the advertisement a₃ associated with user population x₂ to each of the forecasted impressions i₂x₂ and i₃x₂) constitute an advertisement and forecasted impression set.

A source node is defined having an edge to each of the advertisement nodes (512). Each edge from the source node to an advertisement node has a capacity has a capacity corresponding to a sum of the maximum numbers of times the advertisement is to be presented to each associated user population (i.e., the sum of the frequency caps for each of the user populations associated with the advertisement represented by the advertisement node). The association module 218 can, for example, define a source node 614 with edges 616 to the advertisement nodes 604.

A sink node is defined having an edge from each of the impression nodes (514). Each edge to the sink node from an impression node has a capacity of one. The association module 218 can, for example, define a sink node 612 with edges 618 from each of the impression nodes 602.

Once the graph 600 is generated, a variety of max flow algorithms can be used to find the maximal flow f from the source s to the sink t, which is the solution data. Example algorithms include the Ford-Fulkerson algorithm, Edmonds-Karp algorithm, Dinitz blocking flow algorithm, and others. Once generated, the solution data are used by an advertisement allocation system 212 to determine which advertisements to provide in response to impression events.

Generally described, multiple solution sets can be generated by finding a first solution set, removing the edges representing matches of advertisements to forecasted impressions comprising the first solution set, finding a second solution set, removing the corresponding edges comprising the second solution set, and so on.

### §3.0 Example Processing System

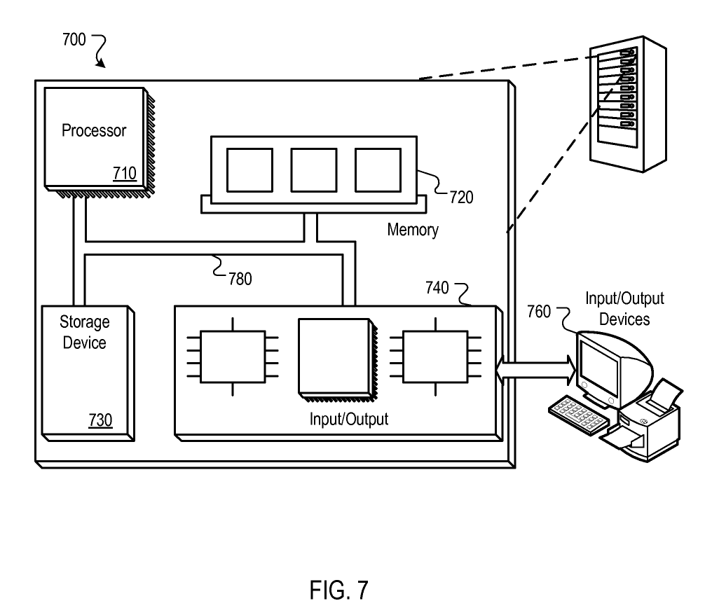

FIG. 7 is block diagram of an example computer processing system 700 that can be used to allocate and provide advertisements in response to impression events corresponding to forecasted impressions based on forecasting data and advertisement availability data. The system 700 can be used to realize a variety of different types of computer devices, such as the client devices 208 or server and computer devices on which the advertising system 204 and the advertisement allocation system 212 are implemented.

The system 700 includes a processor 710, a memory 720, a storage device 730, and an input/output device 740. Each of the components 710, 720, 730, and 740 can, for example, be interconnected using a system bus 780. The processor 710 is capable of processing instructions for execution within the system 700. In one implementation, the processor 710 is a single-threaded processor. In another implementation, the processor 710 is a multi-threaded processor. The processor 710 is capable of processing instructions stored in the memory 720 or on the storage device 730.

The memory 720 stores information within the system 700. In one implementation, the memory 720 is a computer-readable medium. In one implementation, the memory 720 is a volatile memory unit. In another implementation, the memory 720 is a non-volatile memory unit.

The storage device 730 is capable of providing mass storage for the system 700. In one implementation, the storage device 730 is a computer-readable medium. In various different implementations, the storage device 730 can, for example, include a hard disk device, an optical disk device, or some other large capacity storage device.

The input/output device 740 provides input/output operations for the system 700. In one implementation, the input/output device 740 can include one or more of a network interface devices, e.g., an Ethernet card, a serial communication device, e.g., and RS-232 port, and/or a wireless interface device, e.g., an 802.11 card. In another implementation, the input/output device can include driver devices configured to receive input data and send output data to other input/output devices, e.g., keyboard, printer and display devices 760. Other implementations, however, can also be used, such as mobile computing devices, mobile communication devices, etc.

Although an example processing system has been described in FIG. 7, embodiments of the subject matter and the functional operations described in this specification can be implemented in other digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. The computer readable medium can be a machine readable storage device, a machine readable storage substrate, a memory device, or a combination of one or more of them.

A computer program (also known as a program, software, software application, script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Additionally, the logic flows and structure block diagrams described in this patent document, which describe particular methods and/or corresponding acts in support of steps and corresponding functions in support of disclosed structural means, may also be utilized to implement corresponding software structures and algorithms, and equivalents thereof. The processes and logic flows described in this specification can be performed by one or more programmable processors executing one or more computer programs to perform functions by operating on input data and generating output.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

The computing system can include clients and servers. A client and server are generally remote from each other and typically interact through a communication network. The relationship of client and server arises by virtue of computer programs running on the respective computers and having a client server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results. As one example, the processes depicted in the accompanying Figures do not necessarily require the particular order shown, or sequential order, to achieve desirable results. In certain implementations, multitasking and parallel processing may be advantageous.

This written description sets forth the best mode of the invention and provides examples to describe the invention and to enable a person of ordinary skill in the art to make and use the invention. This written description does not limit the invention to the precise terms set forth. Thus, while the invention has been described in detail with reference to the examples set forth above, those of ordinary skill in the art may effect alterations, modifications and variations to the examples without departing from the scope of the invention.

What is claimed is:

1. A computer-implemented method, comprising:
identifying forecasting data defining forecasted impressions for a plurality of user populations for a time period, each forecasted impression associated with a corresponding user population;
identifying advertisement availability data defining availabilities of advertisements to be provided during the time period, each advertisement associated with one or more user populations, each advertisement and user population being associated with a corresponding maximum number of times the advertisement is to be presented to the user population;
generating solution data comprising a solution set defining a plurality of advertisement and forecasted impression sets, wherein each advertisement and forecasted impression set includes no more than its corresponding maximum number of advertisement and forecasted impression pairs, and each advertisement and forecasted impression pair in the advertisement and forecasted impression set defines a match of the advertisement to one forecasted impression associated with the same user population as the advertisement, wherein the one forecasted impression is matched only once; and
in response to an impression event corresponding to a forecasted impression, providing the advertisement matched with the forecasted impression according to the advertisement and impression pair corresponding to the forecasted impression.

2. A method of claim 1, wherein generating the solution data comprises:
representing each forecasted impression by an impression node;
representing each advertisement by an advertisement node;
for each advertisement and each user population associated with the advertisement, defining a user node;
for each advertisement node, defining an edge between the advertisement node and each associated user node, the edge having a capacity corresponding to the maximum number of times the advertisement represented by the advertisement node is to be presented to the associated user population;
defining edges between the user nodes and the impression nodes having the same user populations based on the advertisement availability data and the forecasting data, each edge having a capacity of one;
defining a source node having an edge to each advertisement node; and
defining a sink node having an edge from each impression node, each edge having a capacity of one.

3. The method of claim 2, wherein the edge from the source node to an advertisement node has a capacity corresponding to a sum of the maximum numbers of times the advertisement is to be presented to each associated user population.

4. The method of claim 1, wherein a user population defines a user demographic.

5. The method of claim 1, wherein a user population defines a particular user.

6. The method of claim 1, wherein a user population defines a geographic region.

7. The method of claim 1, wherein a user population defines a web browser type.

8. A system, comprising:
a forecasting module configured to:
identify forecasting data defining forecasted impressions for a plurality of user populations for a time period, each forecasted impression associated with a corresponding user population; and
identify advertisement availability data defining availabilities of advertisements to be provided during the time period, each advertisement associated with one or more user populations, each advertisement and user population being associated with a corresponding maximum number of times the advertisement is to be presented to the user population;
an association module configured to:
generate solution data comprising a solution set defining a plurality of advertisement and forecasted impression sets, wherein each advertisement and forecasted impression set includes no more than its corresponding maximum number of advertisement and forecasted impression pairs, and each advertisement and forecasted impression pair in the advertisement and forecasted impression set defines a match of the advertisement to one forecasted impression associated with the same user population as the advertisement, wherein the one forecasted impression is matched only once; and
an advertisement selection module configured to provide the advertisement matched with the forecasted impression according to the advertisement and impression pair corresponding to the forecasted impression in response to an impression event corresponding to a forecasted impression.

9. The system of claim 8, wherein the association module is configured to generate a max-flow solution defining the solution data.

10. The system of claim 8, wherein the association module is configured to:
represent each forecasted impression by an impression node;
represent each advertisement by an advertisement node;
for each advertisement and each user population associated with the advertisement, define a user node;
for each advertisement node, define an edge between the advertisement node and each associated user node, the edge having a capacity corresponding to the maximum number of times the advertisement represented by the advertisement node is to be presented to the associated user population;
define edges between the user nodes and the impression nodes having the same user populations based on the advertisement availability data and the forecasting data, each edge having a capacity of one;
define a source node having an edge to each advertisement node; and
define a sink node having an edge from each impression node, each edge having a capacity of one.

11. The system of claim 10, wherein the edge from the source node to an advertisement node has a capacity corresponding to a sum of the maximum numbers of times the advertisement is to be presented to each associated user population.

12. The system of claim 8, wherein a user population defines a user demographic.

13. The system of claim 8, wherein a user population defines a particular user.

14. The system of claim 8, wherein a user population defines a geographic region.

15. The system of claim 8, wherein a user population defines a web browser type.

16. One or more computer readable media storing instructions executable by a processing system, and upon such execution cause the processing system to perform operations comprising:
identifying forecasting data defining forecasted impressions for a plurality of user populations for a time period, each forecasted impression associated with a corresponding user population;
identifying advertisement availability data defining availabilities of advertisements to be provided during the time period, each advertisement associated with one or more user populations, each advertisement and user population being associated with a corresponding maximum number of times the advertisement is to be presented to the user population;
generating solution data comprising a solution set defining a plurality of advertisement and forecasted impression sets, wherein each advertisement and forecasted impression set includes no more than its corresponding maximum number of advertisement and forecasted impression pairs, and each advertisement and forecasted impression pair in the advertisement and forecasted impression set defines a match of the advertisement to one forecasted impression associated with the same user population as the advertisement, wherein the one forecasted impression is matched only once; and
in response to an impression event corresponding to a forecasted impression, providing the advertisement matched with the forecasted impression according to the advertisement and impression pair corresponding to the forecasted impression.

17. The computer readable media of claim 16, wherein generating solution data comprises:
representing each forecasted impression by an impression node;
representing each advertisement by an advertisement node;
for each advertisement and each user population associated with the advertisement, defining a user node;
for each advertisement node, defining an edge between the advertisement node and each associated user node, the edge having a capacity corresponding to the maximum number of times the advertisement represented by the advertisement node is to be presented to the associated user population;
defining edges between the user nodes and the impression nodes having the same user populations based on the advertisement availability data and the forecasting data, each edge having a capacity of one;
defining a source node having an edge to each advertisement node; and
defining a sink node having an edge from each impression node, each edge having a capacity of one.

18. The computer readable media of claim 17, wherein the edge from the source node to an advertisement node has a capacity corresponding to a sum of the maximum numbers of times the advertisement is to be presented to each associated user population.

19. The computer readable media of claim 16, wherein a user population defines a user demographic.

20. The computer readable media of claim 16, wherein a user population defines a particular user.
